(19) United States
(12) Patent Application Publication
(10) Pub. No.: US 2010/0291527 A1
(43) Pub. Date: Nov. 18, 2010

(54) Kit and process for diagnosing multiple intelligences profile

(76) Inventor: Jennifer Baldi, Stony Brook, NY (US)

Correspondence Address: Magda Carvalho, 25 Glenview Drive, Southampton, NY, 11968, US

(21) Appl. No.: 12/454,150

(22) Filed: May 12, 2009

(51) Int. Cl. G09B 3/00

(52) U.S. Cl. 434/322

(57) ABSTRACT

A kit and process of using for diagnosing multiple intelligences profile of an individual with verbal communication limitations from observational behavior. The kit includes a diagnostic device (101), a set of intelligence cards (102), an introduction material (103), a housing (104), a set of toys (105), a ranking sheet (106), and a manual (107). The process (50) includes steps for utilizing the kit; whereby when all intelligences have been assessed the individual would have obtained a profile of the multiple intelligences at a given time.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This application relates to a diagnostic educational aid and, more particularly, relates to a kit and process of using containing visual aids and a process to diagnose multiple intelligences profile of individuals with verbal communication limitations from observable behavior.

### BACKGROUND OF THE INVENTION

Multiple Intelligences (MI) theory, developed by Professor Howard Gardner of Harvard Graduate School of Education (Gardner 1983), defines intelligence by what people can do in the real world. MI theory acknowledges that all persons have several categories of intelligences in unequal proportions. As such, each individual possesses a unique MI profile at a given time. This is so because intelligences can be enhanced, and as result, the MI profile changes as the intelligences are developed. The earlier a child is diagnosed with an MI profile, the sooner the child can be helped in honing weaknesses and enhancing strengths.

As to autistic children, research shows that warning signs can be spotted in a 6-month-old child. Early intervention during sensitive periods of brain development can greatly benefit the child. Thus, if an MI profile for the autistic child is created at an early age, then his or her strengths and weaknesses can be properly addressed. As result, such children can achieve their full potential and thus grow, recognizing their special abilities.

Based on Dr. Gardner's theory, all persons possess eight different types of learning intelligences: verbal/linguistic, logical/mathematical, visual/spatial, musical/rhythmic, bodily/kinesthetic, interpersonal, intrapersonal and naturalist. Verbal type intelligence relates to words and meanings. Logical type analyses patterns and thinks logically. Visual type thinks in pictures and images. Musical type is sensitive to environmental sounds. Kinesthetic type uses the body to solve problems or make things. Interpersonal type understands other people's emotions and feelings. Intrapersonal type appreciates his/her feelings and emotions. Naturalist type is sensitive to natural phenomena. For more information about multiple intelligences, see, Gardner, Howard. (1983), Frames of Mind: The Theory of Multiple Intelligences. New York, N.Y.: Basic Books; Gardner, Howard. (1993), Multiple Intelligences: The Theory in Practice, New York, N.Y.: Basic Books; and Dunn, R. and Dunn, K. (1987), Understanding the learning styles and the need for individual diagnosis and prescription, Columbia, Conn.: The Learner's Dimension.

Learning styles is the natural way individuals put dominant intelligences to work. Learning styles matter because the individual learns most easily via the modes with which they feel most confident (e.g., via dominant intelligences). As a result, children choose activities which correspond to their strongest intelligences. For example, some children enjoy puzzles and shape sorting. Others consistently reach for blocks, trains or books, while others change their attention focus and cooperate when music is used.

It is well recognized that the earlier the children can be diagnosed as to their learning styles, the better the results achieved by early intervention to encourage honing of the various intelligences. Intelligences can be enhanced by early intervention. For example, children with autism, if assessed early enough, can be taught techniques to overcome a given difficulty by using their strongest intelligences. Gifted children can be stimulated based on their learning styles at an early stage. Moreover, all children benefit from early diagnose of MI since weaknesses can be overcome by designing a personalized teaching plan to compensate for such weaknesses.

Currently, tests assessing MI profiles are not designed to diagnose the individual with verbal communication limitations, who might be using movement of the eyes to express themselves (e.g., infants, autistic and/or mentally handicapped individuals). Usually, the assessment of an MI profile can be achieved by either self-reporting or by observing the behavior of the learner. The self-reporting diagnosis can be achieved through a questionnaire using a computer (electronic learning) as described or disclosed in U.S. Patent Publication No. 2005/0186550 published Aug. 25, 2005 to Gillani; and U.S. Patent Publication No. 2004/0009462 published Jan. 15, 2004 to McElwrath. However, electronic learning is not feasible for very young children with verbal communication limitations. The best indicator of a child's learning preferences is still by observing the individual. However, in a classroom setting, catching a child in action and documenting the child's preferred intelligences may not be reliable due to the high-pressure play, peer influence and frustration. The problem with these tests is that they require verbal and/or written communication. As to a child with verbal communication limitations, in particularly the autistic child, the MI theory has been addressed as an instructional method for teaching. However, the method fails to provide a method of assessing the child's MI profile. Christy L. Magnusen, foreword by Tony Attwood (2005) Teaching Children with Autism and Related Spectrum Disorders: An Art and Science, Jessica Kingsley Publication.

In view of the above, a need remains for a system and method to assist caregivers, parents and teachers to diagnose the MI profile of an individual with verbal communication limitations (e.g, infant to 3 years, autistic children and/or children with mental disabilities). Another need is that such system and method be utilized on a one-to-one basis, that it utilizes visual clues and manual manipulation, and that its assessment comes from observational behavior. Yet another need is that the system and method should be such that it can be used on a continued basis because the MI profile changes as the particular intelligences develop. Still another need, requires that such method be simple, easy and affordable. Thus, a system and method solving the aforementioned problems is desired. The present invention is directed to fulfilling these needs.

### SUMMARY OF THE INVENTION

The need remaining in the prior art is addressed by the present invention, which relates to a kit and process of using for diagnosing the profile of multiple intelligences of an individual with verbal communication limitations (for example, infant to 3 years olds, autistic and the mentally disabled individuals) by observation of behavior. The multiple intelligences, for purposes of the present invention, comprise: (a) verbal/linguistic; (b) logical/mathematical; (c) visual/spatial; (d) musical/rhythmic; (e) bodily/kinesthetic; (f) interpersonal; (g) intrapersonal and (h) naturalist.

In accordance with the present invention, a kit has been developed to diagnose the multiple intelligences profile of an individual with verbal communication limitations. The kit of the present invention is used to carry out the method of the present invention. The kit includes a diagnostic device, a set of intelligence cards, introduction material, a housing, a set of toys, a ranking sheet, and an instructional manual.

The diagnostic device is a physical object having affixed to it a plurality of see-through pockets predetermined to carry at least one card. Each pocket is covered by a distinctly colored flap having printed thereon indicia corresponding to each of the intelligences, and each flap is hinged over the respective pockets. The set of cards includes a plurality of graphic images representing activities corresponding to the multiple intelligences. Each card has a graphic image corresponding to activities related to each of the intelligences. The introduction material has information leading an individual to activities experienced by the diagnostic device, each activity is related and correspond to each of the intelligences. The housing contains the set of toys. The set of toys includes a plurality of toys corresponding to each of the intelligences. The ranking sheet includes a plurality of units for predicting the individual's multiple intelligences profile. The manual has instruction guiding the caregiver on the steps of the process of using the kit, including suggested activities for engaging individuals in activities designed to improve weaker categories of the intelligences by using dominant intelligences, and further suggesting activities to improve strengths.

Picture cards have been previously used in teaching systems for developmentally disabled children, such as the well-known Picture Exchange Communication System (or “PECS”), wherein a child is given a set of pictures of favorite foods or toys to a communicative partner in exchange for that item. As will be appreciated from the description herein of the present invention, the manner in which the present invention utilizes picture cards differs significantly from the teaching of PECS.

In accordance with the present invention, a process has been developed for diagnosing a profile of multiple intelligences of an individual with verbal communication limitations. The process comprises the steps of: (a) having the caregiver review the manual; (b) introducing the multiple intelligences in the form of a story of a plurality of activities experienced by the diagnostic device; (c) engaging the individual in exploring the diagnostic device; (d) having the caregiver lift flaps of the pockets affixed to the diagnostic device for the individual to see the picture cards inside of the pockets; (e) helping the individual to make association between the flaps of the pockets and the picture cards inside of the pockets with the diagnostic device and the set of toys contained in the housing; (f) engaging the individual to select one flap on his/her own; (g) having the individual lift the flap to see the picture card inside of the pocket; (h) having the individual point to the picture card inside of the pocket; (i) having the individual look at the caregiver to give the individual a toy corresponding to that activity represented in the picture card; (j) having the caregiver hand to the individual the toy corresponding to the picture card; (k) recording on the ranking sheet the intelligence corresponding to the flap first chosen as highest level of preference; and (1) repeating steps (b) thru (k) for the second time and recording the intelligence chosen by the individual as high level of preference, repeating the process for a plurality of multiple intelligences, whereby a profile of an individual's multiple intelligences is obtained.

The present invention provides a new and improved kit and process of using for diagnosing the multiple intelligences profile of an individual with verbal communication limitations and one which has all the advantages of the prior art and none of the disadvantages of the prior art in diagnosing a multiple intelligences profile from observed behavior.

The present invention further provides a new system and method for diagnosing a multiple intelligences profile that is susceptible of low-cost of manufacturing, and which accordingly is susceptible of low price-of-sale to the consuming public, thereby making such a system and method economically available to the consuming public.

One advantage of the present invention is that it provides educational and therapeutic aid in the form of toys which a child with verbal communication limitations can handle and play with individually.

Another advantage of the present invention is that the kit is portable, light-weight and easily fits into a backpack, and or the like.

It is a further advantage of the present invention that it provides education and information regarding the use of multiple intelligences theory.

The profile of multiple intelligences enables important intelligence deficiencies to be identified for subsequent honing and improvement. The categories of multiple intelligences correspond to particular areas of scientific research. For that reason, approaches for remedying any intelligence type deficiency can be selected from existing psychological and educational programs.

These together with other objects of the present invention, along with various features of novelty which characterize the invention, are pointed out with particularity in the claims annexed to and forming a part of this disclosure. For a better understanding of the invention and its operating advantages, and the specific objects attained by its uses, reference should be had to the accompanying drawings and descriptive matter.

### DRAWINGS—FIGURES

The present invention is illustrated by way of example, and not of limitation, in the accompanying figures, in which like references indicate similar elements, and in which:

FIG. 1 is a diagram illustrating an exemplary system that may be used with the process of FIG. 5 for diagnosing the multiple intelligences profile of individuals with verbal communication limitations;

FIG. 2 is a front view of a the preferred embodiment of the diagnostic device in the form of a teddy bear, with a partially exploded plain view of a pocket with a card inserted therein, that may be used with the process of FIG. 5 to diagnose a multiple intelligences profile;

FIG. 3 illustrates exemplary graphic images printed on the intelligence cards in accordance with the present invention;

FIG. 4 contains a table of an exemplary “multiple intelligences profile” ranking that may be used with the inventive process of FIG. 5 to record information concerning an individual's levels of preference for particular intelligences and thereby diagnose an individual's learning styles; and

FIG. 5 includes a flowchart illustrating the overall process of the present invention as used to diagnose an individual's multiple intelligences profile.

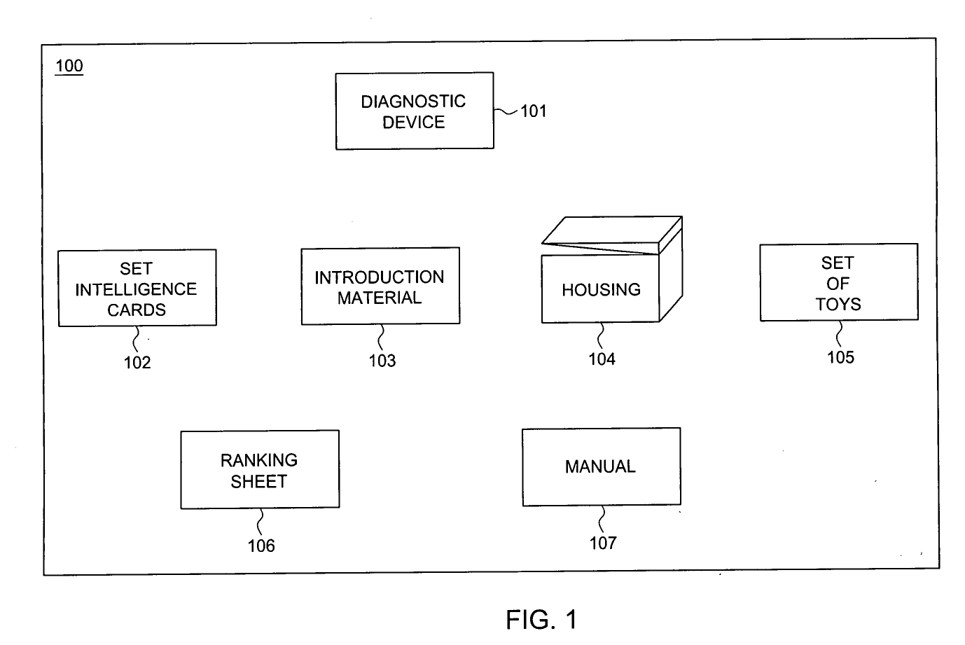

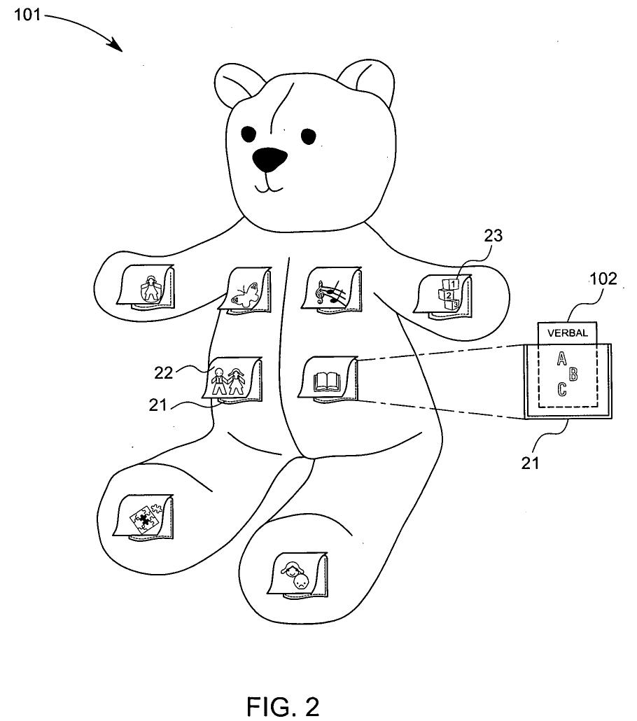

### DETAILED DESCRIPTION—FIGS. 1, 2,3,4 AND 5—PREFERRED EMBODIMENT

In accordance with the teachings of the present invention, a system and process of using has been developed for individuals with verbal communication limitations that will sequentially utilize a set of aids to diagnose a profile of multiple intelligences: (a) verbal/linguistic; (b) logical/mathematical; (c) visual/spatial; (d) musical/rhythmic; (e) bodily/kinesthetic; (f) interpersonal; (g) intrapersonal and (h) naturalist. At times throughout the course of the following discussion, these multiple intelligences may be referred to as “learning styles.”

The system and process of the present invention are applicable to individuals with verbal communication limitations of various ages, developmental stages, mental difficulties, mental disabilities, prodigies, savants, and/or exceptional individuals.

The term “caregiver” includes any person who cares for an individual for any period of time. The term “caregiver” shall be understood to include a parent, relatives, a neighbor, a babysitter, a daycare worker, a teacher, a nurse, or anyone else who is charged with the care of an individual with verbal communication limitations.

For the purposes of the current discussion, the embodiments of the present invention will be explained in terms of an exemplary embodiment directed to the very young child who has not yet developed language, and more particularly the young autistic child. While these exemplary embodiments are described in sufficient detail to enable those skilled in the art to practice the present invention, it should be understood that other embodiments may be realized, and that changes may be made without departing from the spirit and scope of the invention. It is to be understood that the below examples are merely illustrative of the inventive methodology. Thus, the following detailed description is presented for purposes of illustration only and not of limitation, and the scope of the invention is defined solely by the appended claims.

FIG. 1 illustrates an exemplary kit 100 for diagnosing multiple intelligences profile in accordance with the present invention. Kit 100 is designed to give caregivers an easy and inexpensive means to diagnose multiple intelligences profiles (learning styles) of individuals with verbal communication limitations, and may be adapted for use with a child at a particular age and or mental disability. In the preferred embodiment, kit 100 embodies and combines some of the findings of the inventor's own research and work with autistic children and presents these findings in a form that may be understood and implemented in a practical manner by caregivers. As illustrated in FIG. 1, exemplary kit 100 comprises a diagnostic device 101, a set of intelligence cards 102, an introduction material 103, a housing 104, a set of toys 105, a ranking sheet 106 and a manual of instructions for the caregiver 107.

Diagnostic Device

The diagnostic device 101 is a physical object, with a plurality of pockets affixed to its body, that attracts the attention and interest of an individual with verbal communication limitations and aids in the diagnosis of the multiple intelligences profile of the individual (e.g., a board, toy, cartoon character, piece of cloth, puppet). A preferred embodiment of the present invention comprises a diagnostic device teddy bear 101 having affixed to its body at least eight pockets 21 for placing the cards 102 as illustrated in FIG. 2. The pockets 21 are made of see-through material. The pockets 21 may be of any shape and located anywhere on the teddy bear 101. Each pocket 21 should allow room for the at least one card 102 to be inserted into the pocket 21.

Each pocket 21 includes a flap 22 which is illustrated in FIG. 2. Each flap 22 is of a distinctly color and has indicia 23 printed thereon relating to an activity corresponding to a one category of the multiple intelligences as illustrated in FIG. 2. As way of example, FIG. 2 illustrates that the musical intelligence is represented by musical notes; the verbal is represented by a book; the logical is represented by a puzzle; the visual/spatial is represented by building blocks; the kinesthetic is represented by a girl jumping rope; the interpersonal is represented by people; the intrapersonal is represented by faces showing emotions; and the naturalist is represented by a butterfly. Although specific drawings are shown as indicia 23, other appropriate indicia 23 may include symbols, intelligence's name, objects, actions, places or characters. Indicia 23 are configured to relate to the matching graphic images 31 on the cards 102 inserted in the pockets 21. For example, pocket 21 flap 22 bearing indicia 23 corresponding to the “verbal” intelligence may include a book and the card 102, inside of the pocket 21, which bears the graphic image 31 corresponding to the same intelligence may depict letters of the alphabet as illustrated in FIG. 2. In one embodiment the indicia 23 on the flaps 22 of the pockets 21 are the name of each category of the intelligences.

Each flap 22 is hinged over the pocket 21. Each flap 22 is of sufficient size to extend over and cover the pocket 21. When a given flap 22 is closed it hides the pocket 21 from immediate view. Each flap 22 is readily moved to the open position by the child. In this open position the card 102 inside the pocket 21 of the open flap 22 is now visible.

Set of Cards

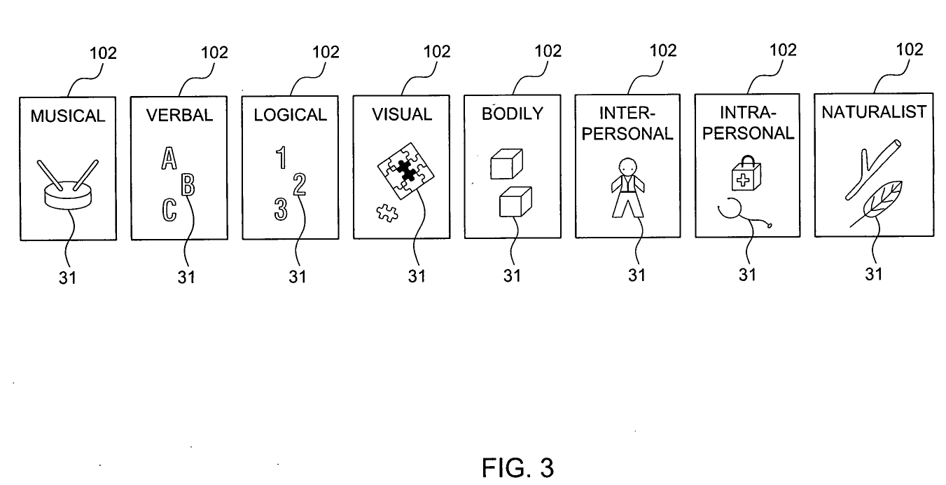

The set of intelligence cards includes at least eight cards. Each card 102 may in fact be cards, tokens, toys or other elements that can be secured in the pocket 21 affixed to the body of diagnostic device 101. Each card 102 is configured and dimensioned to be inserted into a pocket 21. Each card 102 is inserted in the pocket 21 which flap 22 matches the card's 102 identified intelligence. The set of cards 102 has printed thereon graphic images 31 corresponding to activities related to the multiple intelligences as illustrated in FIG. 3 by way of example. However, any pictorial representation, symbol or other appropriate depiction could be used. Each card 102 has a graphic image 31 printed thereon corresponding to an activity related to one intelligence. In one embodiment each card 102 is in the form of photography. In another embodiment, the back of each card 102 identifies activities corresponding to the intelligence depicted on the front. In yet another embodiment, the back of the card 102 can contain factual information about the intelligence depicted on the front.

Introduction Material

The introduction material 103 may include any form of materials (for example, written, electronic, audio tape, video tape and/or like forms or mediums) that provide information in the form of a short story that is predetermined around concepts of the multiple intelligences. The diagnostic device is the character of the story. The story is an account of the diagnostic device's 101 own experiences while having fun activities. Each activity is focused on and associated with a different category of the multiple intelligences. Each activity relates in content to the picture contained in the graphic image 31 on each card 102. All categories of the intelligences are encompassed by the activities experienced by the diagnostic device 101 as told in the story. In one embodiment, the story may be in the form of narrative, rhymes, poems, songs or finger play.

In the preferred embodiment, the introduction material 103 is a book in which the story tells how the teddy bear 101 experienced different activities corresponding to each category of the multiple intelligences. By way of example, the story may be outlined as having the teddy bear 101 loving to listen to tales in a book and also seeing the words (verbal smart); the teddy bear 101 liking to count its jellybeans before eating them and always comparing the amount of jellybeans it eats to the amount of jellybeans its best friend eats (logical smart); the teddy bear 101 being fascinated in situating every piece of its puzzle (visual smart); the teddy bear 101 being very enthusiastic in playing while listen to music and enjoying making music with its musical instruments (musical smart); the teddy bear 101 enjoying building block towers (kinesthetic smart); the teddy bear 101 getting sad when the puppet was upset and the teddy bear 101 being happy when the puppet was cheerful (interpersonal smart); the teddy bear 101 liking to play alone with its doctor's kit (intrapersonal smart); and the teddy bear 101 greeting being outdoors playing with bugs (naturalist smart).

Housing

The housing 104 may include any suitable apparatus capable of containing or enclosing at least a set of toys 105. For example, housing 104 may include a basket, a bin, a tub, a child's traveling or business suitcase, a crate, a backpack and/or the like. Housing 104 may be made of any suitable material, including cloth, cardboard, synthetic material, wood, wicker, metal and/or the like. In the preferred embodiment the housing 104 is in the form of backpack made of plastic.

Set of Toys

The set of toys 105 are contained into the housing 104. The set 105 contains at least eight toys covering the full range of the various multiple intelligences. The set 105 may include items of any kind that can be used by an individual to associate to a particular intelligence. At least one toy 105 corresponds to each of the intelligences. An exemplary set 105 includes a ball (kinesthetic), a flute (musical), a book (linguistic), a map (visual/spatial), a dinosaur figure (interpersonal), items of facial expressions (intrapersonal), numbers (logical), ajar containing plastic bugs (naturalistic). Exemplary toys may include any of the following: games, small toy manipulative to count, colorful items, figure dolls, items representing the nature, sound-making items, maps, stuffed animals, compact discs, blocks for stacking, household items, puppets, balls, interlocking blocks or toys (e.g., Lego®, Tinkertoys®, and/or the like), items representing facial expressions, toys with moving parts, books, puzzles, beads, pictures, musical instruments, paper, art mediums, letters of the alphabet, numbers, and/or the like.

Ranking Sheet

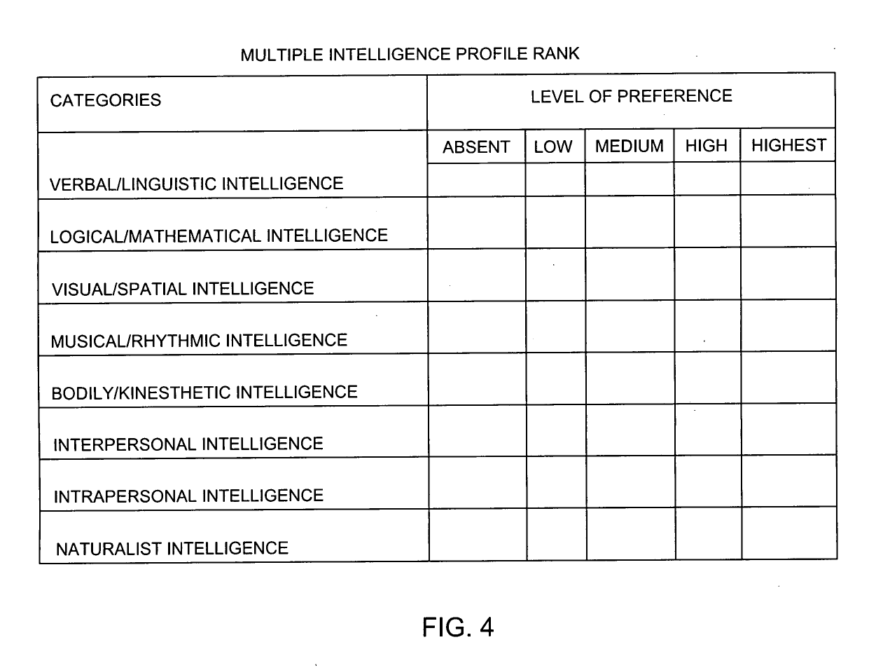

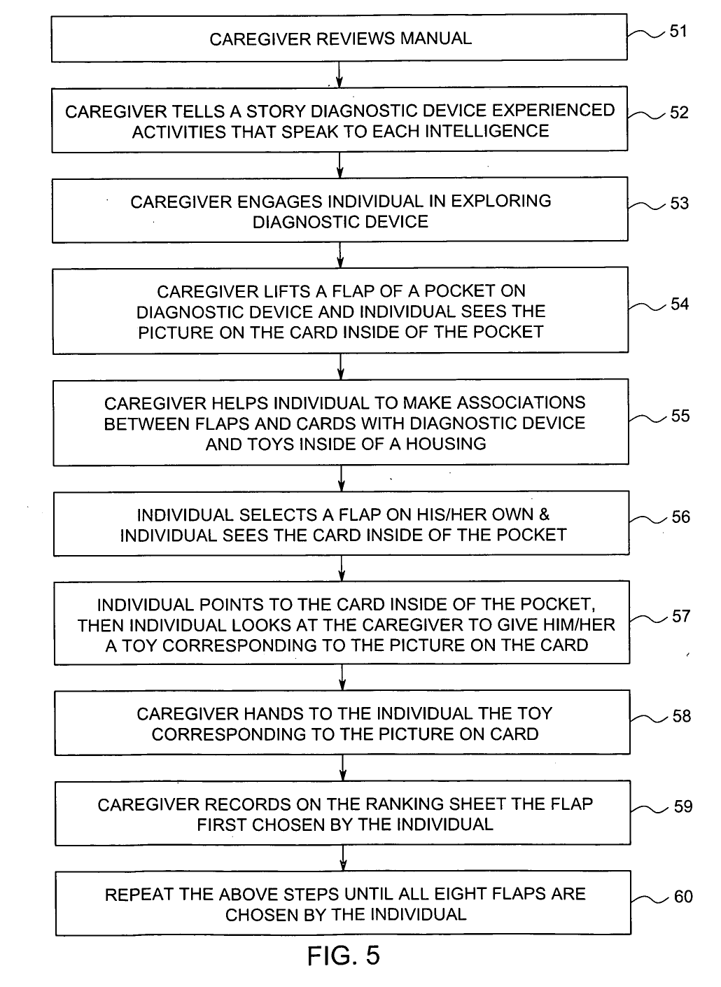

The ranking sheet 106, namely, Multiple Intelligences Profile Rank, is illustrated in more detail in FIG. 4. The sheet may be associated with the decision to repeat the inventive process 50, as outlined in FIG. 5, at different times of the development of the individual. In particular, the ranking sheet of FIG. 4 is used to create a profile of multiple intelligences of an individual with verbal communication limitations at a given time. The multiple intelligences, as outlined above, are shown as eight separate categories. FIG. 4 shows that the sheet is broken into a five-part range for assessing an individual's preferences for each intelligence with the lowest end of the range showed as “absent” and the highest end of the range shown “highest,” with the remaining elements within the range denned as “low,” “medium,” and “high.” Various other ranges may be used. Thus, when using the sheet of FIG. 4, a caregiver performing the diagnosis of a child after using the process 50 outlined in FIG. 5 would create a multiple intelligences profile for that child at a given time of the development.

Manual

The manual 107 describes the kit, the process of its use and provides information how to improve intelligences, including putting the dominant intelligences to work in order to improving a weaker one. For example, for a visual child the caregiver can make an art project into a math or other lessons; the kinesthetic child needs to get physical in all the subjects (e.g., counting with clapping); the musical child uses sounds to learn; the logistical child likes to explore and think about the subject matter; the verbal child likes to discuss and debate; the interpersonal child learns better in a group; the intrapersonal child prefers to play/study alone; and the naturalist child likes to identify plants/insects.

### Operation—FIG. 5

The use of the kit of the present invention may now be understood. FIG. 5 illustrates a flowchart which outlines the overall process 50 flow to be used in diagnosing the multiple intelligences profile in accordance with the present invention. As previously mentioned, although the process of the present invention is useful for individuals with verbal communication limitations of any age, exemplary elements as shown in the flowchart of FIG. 5 are most suitable for use with autistic children and/or infant to 3 years old. Referring to FIG. 5, the process 50 may be adapted for use with a child at a particular age, stage and/or mental disability.

In the preferred embodiment, the first step of the process 50 is to have the caregiver review all the materials of the kit and instruction manual prior to commencement of the process (block 51).

Information about the level of preference for each category of the multiple intelligences is then collected by carrying out the following steps. The process 50 then begins with the caregiver reading the introduction material 103 in the form of a book with a story (block 52). The story tells about playing activities, connected to the multiple intelligences, experienced by the teddy bear 101 while having fun. The object is to bring the activities corresponding to each of the intelligences to life, by getting the child involved with the teddy bear's 101 activities.

In the next step, the caregiver presents the teddy bear 101 to the child (block 53). Here, the child explores and touches the teddy bear 101. The object here is for the child familiarize with the teddy bear 101.

Next, the caregiver lifts one flap 22 of the pocket 21 affixed to the body of the teddy bear 101 and the child sees the graphic image 31 printed on the card 102 inside of the pocket 21; then the caregiver discusses with the child that graphic image 31. The caregiver introduces each of the intelligences to the child one at a time. The caregiver repeats this step until all eight flaps 21 are open and all graphic images 31 are seen by the child (block 54).

Next, the caregiver helps the child to make connections between the set of toys 105 inside of the housing 104 and the graphic images 31 with the teddy bear's 101 own activities as told in the story (block 55). The object here is to forge a bond between the teddy bear 101 and the child by sharing play experiences and, thus, more quickly establish those experiences in the child's mind.

The next step involves the child choosing a flap 22 on his or her own, then the child or the caregiver lifts the flap 22 and the child views the graphic image 31 printed on the card 102 inside the pocket 21 (block 56). The flap first chosen by the child may indicate his or her highest level of preference for a particular intelligence.

Next, the child points to the graphic image 31 on the card 102 by gesturing, verbalizing or muttering at the picture; then the child looks at the caregiver to give him or her a toy in the set of toys 105 corresponding to that activity of the graphic image 31 (block 57). The movement of the eyes is the way autistic children and/or children with verbal communication limitations request something. Thus, when eye contact occurs the child signals an interest in one particular activity on his or her own.

In the next step, the caregiver hands to the child one toy in the set of toys 105 that corresponds to that activity of the graphic image 31 on the card 102 (block 58). Now the child can do the activity on his or her own.

Next, the caregiver records on the ranking sheet of FIG. 4 the flap 22 first chosen by the child (block 59). The process described above is then repeated in turn for each of the remaining intelligences (block 60). The intelligence corresponding to the flap 22 first chosen is ranked as “highest,” the intelligence corresponding to the flap 22 of second choice is ranked as “high”, and so on. The object is to have the child to open all the eight flaps 22 of the pockets 21 at different times so that each of the intelligences can be given a rank.

At the completion of the process 50 a profile of multiple intelligences is created by having the caregiver recording on the ranking sheet, as detailed in FIG. 4, the order in which the intelligences were requested at a given time. It is predicted that if a child repeatedly selects a particular flap 22 first, this choice is indicative of the child's dominance or relevance for that particular intelligence. Conversely, weaknesses arise when the child either misses or shows minimal interest in selecting specific flaps 22. As such, strengths and weaknesses emerge as the caregiver observes the child choosing specific flaps 22 over and over in a certain sequence. For example if the child is always lifting the flap 22 corresponding to the musical intelligence first, then the caregiver can identify that one of the child's strengths is “musical” type. In contrast, if the child repeatedly misses choosing the flap 22 corresponding to the verbal intelligence, then the caregiver identifies that the child is not a “verbal” type. The creation of a profile distinguishes intelligences which are less developed from those which are more developed. On this basis, those less developed intelligences can be targeted for improvement.

### Conclusion, Ramifications, and Scope

Thus in accordance with this invention is now possible to diagnose a multiple intelligences profile of an individual with verbal communication limitations (e.g., infant to 3 years old, individuals with mental disabilities and autistic children) from observational behavior. While exemplary drawings and the presently preferred embodiments of the present invention have been described and illustrated, it is to be understood that the scope of the present invention is not to be limited to the particular embodiments discussed. Thus, the embodiments shall be regarded as illustrative rather than restrictive, and it should be understood that various changes can be made therein by workers skilled in the arts without departing from the scope of the present invention as set forth in the appended claims and structural and functional equivalents thereof.

I claim:

1. A kit for diagnosing a multiple intelligences profile of an individual with verbal communication limitations, comprising the combination of:
(a) at least a diagnostic device having affixed to it a plurality of see-through pockets, each pocket is predetermined to carry at least an intelligence card, each said pocket is covered by a distinctly colored flap having thereon printed indicia corresponding to an activity related to a one of said multiple intelligences, each said flap is hinged over said pockets, each said flap is predetermined to cover said pocket;
(b) at least a set of said intelligence cards, said set of intelligence cards having printed thereon a plurality of graphic images corresponding to activities relating to said multiple intelligences, each said intelligence card having printed thereon a graphic image corresponding to an activity related to a one intelligence of said multiple intelligences, each said intelligence card is predetermined to be inserted into said pockets affixed to said diagnostic device;
(c) at least an introduction material developed to provide information introducing said diagnostic device as having experienced activities corresponding to each intelligence of said multiple intelligences;
(d) at least a housing, predetermined to contain a set of toys;
(e) at least a said set of toys, said set includes a plurality of toys corresponding to activities related to said multiple intelligences, each said toy corresponding to a one said activity related to a one intelligence;
(f) at least a ranking sheet including a plurality of units for creating said multiple intelligences profile, each unit corresponding to a rank of preference for a given intelligence, at least three separate ranks of preferences including (1) absent, (2) medium and (3) highest; and
(g) a manual having instruction guiding a caregiver in utilizing said kit including utilizing the steps of a process used to diagnose said multiple intelligences profile by said kit.

2. The kit of claim 1, wherein said multiple intelligences comprise:
(a) verbal/linguistic intelligence;
(b) logical/mathematical intelligence;
(c) visual/spatial intelligence;
(d) musical/rhythmic intelligence;
(e) bodily/kinesthetic intelligence;
(f) interpersonal intelligence;
(g) intrapersonal intelligence; and
(h) naturalist intelligence.

3. The kit of claim 1, wherein said diagnostic device is a physical object developed to assist in diagnosing said multiple intelligences profile.

4. The kit of claim 1, wherein said diagnostic device is a teddy bear developed to assist in diagnosing said multiple intelligences profile.

5. The kit of claim 1, wherein said indicia printed on each said flap of each said pocket on said diagnostic device corresponds to an activity related to a one intelligence selected from the group comprising verbal/ linguistic, logical/mathematical, visual/spatial, musical/rhythmic, bodily/kinesthetic, interpersonal, intrapersonal and naturalist.

6. The kit of claim 1, wherein said set of toys comprises at least eight toys.

7. The kit of claim 6, wherein each said toy in said set of toys corresponds to an activity related a one intelligence selected from the group comprising verbal/ linguistic, logical/mathematical, visual/spatial, musical/rhythmic, bodily/kinesthetic, interpersonal, intrapersonal, and naturalist.

8. The kit of claim 6, wherein said set of toys is predetermined to be contained in said housing, each said toy in said set of toys is predetermined to be contained in said housing.

9. The kit of claim 1, wherein said information contained on said introduction material is predetermined to concern in content to activities experienced by said diagnostic device, said activities are based on and associate with said multiple intelligences, each said activity relates in content to a one said graphic image printed on said card inside of said pocket.

10. The kit of claim 9, wherein each said activity experienced by said diagnostic device relates in content to each said toy in the set of toys inside of said housing.

11. The kit of claim 9, wherein each said activity experienced by said diagnostic device corresponds to a one intelligence selected from the group comprising verbal/linguistic, logical/mathematical, visual/spatial, musical/rhythmic, bodily/kinesthetic, interpersonal, intrapersonal, and naturalist.

12. The kit of claim 1, wherein said housing contains at least a said set of toys.

13. The kit of claim 1, wherein each one of the elements of said kit is developed for diagnosing said multiple intelligences profile of young children in the age range of infant to 3 years old.

14. The kit of claim 1, wherein each one of the elements of said kit is developed for diagnosing said multiple intelligences profile of individuals with autism.

15. A process for utilizing a kit for diagnosing a profile of multiple intelligences of an individual with verbal communication limitations, said process comprising the steps of:
(a) having a caregiver review the manual of said kit;
(b) introducing said multiple intelligences in the form of a story of a plurality of activities experienced by a diagnostic device;
(c) engaging said individual in exploring said diagnostic device;
(d) having said caregiver lift flaps of pockets on said diagnostic device for said individual to see a graphic image on cards inside of said pockets, each said flap is lifted one at a time, said caregiver discusses each said graphic image with said individual one at a time, said caregiver repeats this step until all flaps are open;
(e) helping said individual to make association between said flaps of said pockets and said graphic image on said cards inside of said pockets with said diagnostic device and a set of toys contained in a housing,
(f) engaging said individual to select a one said flap on his/her own,
(g) having said individual to lift said flap to see said graphic image on said card inside of said pocket,
(h) having said individual to point to said graphic image printed on said card inside of said pocket,
(i) having said individual to look at the caregiver to give said individual a toy corresponding to the activity of said graphic image printed on said card,
(j) having said caregiver hand to said individual said toy corresponding to said activity of said graphic image printed on said card, said toy being a one toy in said set of toys inside said housing,
(k) recording on the ranking sheet said flap first chosen by said individual,
(l) repeating steps (b) thru (k) for a plurality of multiple intelligences, each one intelligence being addressed one at a time,
whereby when all intelligences of said multiple intelligences have been assessed, said individual would have obtained said profile of multiple intelligences.

16. The process of claim 15, wherein each one of the steps of said process is developed for young children in the age range of infant to 3 years old.

17. The process of claim 15, wherein each one of the steps of said process is developed for individuals with autism.
